(19) United States
(12) Patent Application Publication
(10) Pub. No.: US 2024/0251456 A1
(43) Pub. Date: Jul. 25, 2024

(54) DEVICE AND METHOD FOR CONTROLLING BLUETOOTH CONNECTION

(71) Applicant: SAMSUNG ELECTRONICS CO., LTD., Suwon-si (KR)

(72) Inventors: Hyungyong LEE, Suwon-si (KR); Yongjin KANG, Suwon-si (KR); Jehwan SEO, Suwon-si (KR); Sanggi OH, Suwon-si (KR)

(73) Assignee: SAMSUNG ELECTRONICS CO., LTD., Suwon-si (KR)

(21) Appl. No.: 18/628,423

(22) Filed: Apr. 5, 2024

Related U.S. Application Data
(63) Continuation of application No. PCT/KR22/10926, filed on Jul. 26, 2022.

(30) Foreign Application Priority Data
Oct. 7, 2021 (KR) 10-2021-0133143

(51) Int. Cl. H04W 76/10

(52) U.S. Cl. CPC H04W 76/10

(57) ABSTRACT

A method of controlling a Bluetooth connection on a Bluetooth host device, the method including detecting a Bluetooth connection event; identifying a connection mode supported by a connection target device, between a first connection mode and a second connection mode; when the connection target device supports both the first connection mode and the second connection mode, registering first connection information corresponding to the first connection mode and second connection information corresponding to the second connection mode; when the connection target device supports the second connection mode registering the second connection information corresponding to the second connection mode; and identifying a current mode indicating a current Bluetooth connection mode, selecting one connection mode from the first connection mode or the second connection mode considering the current mode and the connection mode supported by the connection target device, and establishing a connection with the connection target device using the selected connection mode.

### CROSS-REFERENCE TO RELATED APPLICATION

This application is a bypass continuation of International Application No. PCT/KR2022/010926, filed on Jul. 26, 2022, in the Korean Intellectual Property Receiving Office, which claims priority to Korean Patent Application No. 10-2021-0133143, filed on Oct. 7, 2021, in the Korean Intellectual Property Office, the disclosures of which are incorporated by reference herein in their entireties.

### BACKGROUND

### 1. Field

The following description relates to connection control technology when a Bluetooth device is connected to a host device.

### 2. Description of Related Art

A Bluetooth device may establish a Bluetooth communication connection using either classic Bluetooth or Bluetooth low energy (BLE) technology.

However, classic Bluetooth operates on 79 channels, while BLE operates on 40 channels and classic Bluetooth and BLE have different operating mechanisms, making them mutually incompatible.

Hence, when multiple Bluetooth devices use two connection schemes, it is to either use two Bluetooth transmitters, one for classic Bluetooth and one for BLE, or perform time-division operations to simultaneously operate and support two devices.

However, implementing two Bluetooth transmitters may not only incur additional costs but also cause interference and noise between the transmitters. In addition, time-division operations may degrade audio performance, leading to interruptions in audio.

### SUMMARY

According to an embodiment, the disclosure relates to technology for selecting a connection mode, when a plurality of Bluetooth devices is connected to a host device, considering connection modes that a previously connected Bluetooth device and a newly connecting Bluetooth device may respectively support and for controlling a Bluetooth connection using the selected connection mode.

Additional aspects will be set forth in part in the description which follows and, in part, will be apparent from the description, or may be learned by practice of the presented embodiments.

According to an aspect of the disclosure, a method of controlling a Bluetooth connection on a Bluetooth host device, the method including detecting a Bluetooth connection event; identifying a connection mode supported by a connection target device, between a first connection mode and a second connection mode; when the connection target device supports both the first connection mode and the second connection mode, registering first connection information corresponding to the first connection mode and second connection information corresponding to the second connection mode; when the connection target device supports the second connection mode and does not support the first connection mode, registering the second connection information corresponding to the second connection mode; and identifying a current mode indicating a current Bluetooth connection mode, selecting one connection mode from the first connection mode or the second connection mode considering the current mode and the connection mode supported by the connection target device, and establishing a connection with the connection target device using the selected connection mode.

The method may include the establishing of the connection with the connection target device using the selected connection mode including: when the connection target device supports both the first connection mode and the second connection mode and the current mode is the first connection mode, establishing a connection with the connection target device using the first connection mode; and when the connection target device supports both the first connection mode and the second connection mode and the current mode is the second connection mode, establishing a connection with the connection target device using the second connection mode.

The method may include the establishing of the connection with the connection target device using the selected connection mode including: when the connection target device supports only the second connection mode and the current mode is the second connection mode, establishing a connection with the connection target device using the second connection mode; and when the connection target device supports only the second connection mode and the current mode is the first connection mode, changing a connection mode of a previously connected device to the second connection mode and establishing the connection with the connection target device using the second connection mode.

The method may include the first connection mode indicating a mode for establishing a Bluetooth connection using a Bluetooth low energy (BLE) technique.

The method may include the second connection mode indicating a mode for establishing a Bluetooth connection using a classic Bluetooth technique.

The method may include when the current mode is the second connection mode, detecting a reconnection request from a registered device by performing Bluetooth scanning corresponding to the second connection mode at preset intervals; and when the reconnection request from the registered device is detected, establishing a Bluetooth connection with the registered device requesting a reconnection using the second connection mode.

The method may include when the current mode is the first connection mode, detecting a reconnection request from a registered device by performing Bluetooth scanning corresponding to the first connection mode and Bluetooth scanning corresponding to the second connection mode at preset intervals; when the reconnection request from the registered device is detected during the Bluetooth scanning corresponding to the first connection mode, establishing a Bluetooth connection with the registered device requesting a reconnection using the first connection mode; and when the reconnection request from the registered device is detected during the Bluetooth scanning corresponding to the second connection mode, changing a connection mode of a previously connected device to the second connection mode and establishing a Bluetooth connection with the registered device requesting a reconnection using the second connection mode.

The method may include before the current mode is set, detecting a reconnection request from a registered device by performing Bluetooth scanning corresponding to the first connection mode and Bluetooth scanning corresponding to the second connection mode at preset intervals; when the reconnection request from the registered device is detected during the Bluetooth scanning corresponding to the first connection mode, establishing a Bluetooth connection with the registered device requesting a reconnection using the first connection mode; and when the reconnection request from the registered device is detected during the Bluetooth scanning corresponding to the second connection mode, establishing a Bluetooth connection with the registered device requesting a reconnection using the second connection mode.

The method may include when the current mode is the first connection mode and disconnection of one of connected registered devices is detected, verifying whether there are remaining connected registered devices; and when there are the remaining connected registered devices, maintaining the current mode as the first connection mode.

The method may include when the current mode is the second connection mode and disconnection of one of connected registered devices is detected, verifying whether there are remaining connected registered devices; when there are the remaining connected registered devices, verifying whether there is a device supporting only the second connection mode among the remaining connected registered devices; when it is verified that there is the device supporting only the second connection mode among the remaining connected registered devices, maintaining the current mode as the second connection mode; and when it is verified that there is no device supporting only the second connection mode among the remaining connected registered devices, changing the current mode to the first connection mode and reestablishing a connection with the remaining connected registered devices using the first connection mode.

A method of controlling a Bluetooth connection on a Bluetooth host device, the method including when a current mode indicating a current Bluetooth connection mode is a first connection mode, detecting a reconnection request from a registered device by performing Bluetooth scanning corresponding to the first connection mode and Bluetooth scanning corresponding to a second connection mode at preset intervals; when the reconnection request from the registered device is detected during the Bluetooth scanning corresponding to the first connection mode, establishing a Bluetooth connection with the registered device requesting a reconnection using the first connection mode; and when the reconnection request from the registered device is detected during the Bluetooth scanning corresponding to the second connection mode, changing a connection mode of a previously connected device to the second connection mode and establishing a Bluetooth connection with the registered device requesting a reconnection using the second connection mode.

The method may include when the current mode is the second connection mode and disconnection of one of connected registered devices is detected, verifying whether there are remaining connected registered devices; when there are the remaining connected registered devices, verifying whether there is a device supporting only the second connection mode among the remaining connected registered devices; when it is verified that there is the device supporting only the second connection mode among the remaining connected registered devices, maintaining the current mode as the second connection mode; and when it is verified that there is no device supporting only the second connection mode among the remaining connected registered devices, changing the current mode to the first connection mode and reestablishing a connection with the remaining connected registered devices using the first connection mode.

A Bluetooth connection control device including a Bluetooth communication unit including a first connection mode processing unit configured to process a connection scheme of a first connection mode during Bluetooth communication and a second connection mode processing unit configured to process a connection scheme of a second connection mode during the Bluetooth communication; and a processor configured to, when detecting a Bluetooth connection event, identify a current mode indicating a current Bluetooth connection mode and control establishment of a connection by determining whether to establish a connection with a connection target device using the first connection mode or the second connection mode considering the current mode and a connection mode supported by the connection target device, wherein the processor is configured to identify the connection mode supported by the connection target device between the first connection mode and the second connection mode and when the connection target device supports both the first connection mode and the second connection mode, register first connection information corresponding to the first connection mode and second connection information corresponding to the second connection mode.

The Bluetooth connection control device may include the processor is configured to, when the connection target device supports only the second connection mode, register the second connection information corresponding to the second connection mode.

The Bluetooth connection control device may include the processor is configured to when the connection target device supports both the first connection mode and the second connection mode and the current mode is the first connection mode, establish a connection with the connection target device using the first connection mode; and when the connection target device supports both the first connection mode and the second connection mode and the current mode is the second connection mode, establish a connection with the connection target device using the second connection mode.

The Bluetooth connection control device may include the processor is configured to: when the connection target device supports both the first connection mode and the second connection mode and the current mode is the first connection mode, establish a connection with the connection target device using the first connection mode; and when the connection target device supports both the first connection mode and the second connection mode and the current mode is the second connection mode, establish a connection with the connection target device using the second connection mode.

### BRIEF DESCRIPTION OF DRAWINGS

The above and other aspects and features of certain embodiments of the present disclosure will be more apparent from the following description taken in conjunction with the accompanying drawings, in which:

FIG. 1 is a diagram illustrating a schematic configuration of a Bluetooth system according to an embodiment.

FIG. 2 is a diagram illustrating a configuration of a host device of a Bluetooth system according to an embodiment.

FIG. 3 is a flowchart illustrating a process of controlling a connection of a new Bluetooth device by a host device of a Bluetooth system according to an embodiment.

FIG. 4 is a flowchart illustrating a detailed process of controlling a connection of a new Bluetooth device by a host device of a Bluetooth system according to an embodiment.

FIG. 5 is a flowchart illustrating a process of controlling a reconnection of a Bluetooth device while operating in a second connection mode by a host device of a Bluetooth system according to an embodiment.

FIG. 6 is a flowchart illustrating a process of controlling a reconnection of a Bluetooth device while operating in a first connection mode by a host device of a Bluetooth system according to an embodiment.

FIG. 7 is a flowchart illustrating a process of controlling a reconnection of a Bluetooth device, when a current mode is yet to be set, by a host device of a Bluetooth system according to an embodiment.

FIG. 8 is a flowchart illustrating a processing process when a Bluetooth device is disconnected from a host device of a Bluetooth system while operating in a first connection mode, according to an embodiment.

FIG. 9 is a flowchart illustrating a processing process when a Bluetooth device is disconnected from a host device of a Bluetooth system while operating in a second connection mode, according to an embodiment.

### DETAILED DESCRIPTION

Hereinafter, embodiments will be described in detail with reference to the accompanying drawings. However, various alterations and modifications may be made to the embodiments. Here, the embodiments are not meant to be limited by the descriptions of the present disclosure. The embodiments should be understood to include all changes, equivalents, and replacements within the idea and the technical scope of the disclosure.

The terminology used herein is for the purpose of describing embodiments only and is not to be limiting of the embodiments. The singular forms “a”, “an”, and “the” are intended to include the plural forms as well, unless the context clearly indicates otherwise. It will be further understood that the terms “comprises/comprising” or “includes/including” when used herein, specify the presence of stated features, integers, steps, operations, elements, components or combinations thereof, but do not preclude the presence or addition of one or more other features, integers, steps, operations, elements, components or combinations thereof.

Unless otherwise defined, all terms including technical and scientific terms used herein have the same meaning as commonly understood by one of ordinary skill in the art to which the embodiments belong. Terms, such as those defined in commonly used dictionaries, are to be interpreted as having a meaning that is consistent with their meaning in the context of the relevant art and the present disclosure, and are not to be interpreted in an idealized or overly formal sense unless expressly so defined herein.

When describing the embodiments with reference to the accompanying drawings, like reference numerals refer to like components and a repeated description thereto will be omitted. In the description of embodiments, detailed description of well-known structures or functions will be omitted when it is deemed that such description will cause ambiguous interpretation of the present disclosure.

Also, terms such as first, second, A, B, (a), (b), or the like may be used herein when describing components of the present disclosure. These terms are used only for the purpose of discriminating one component from another component, and the nature, the sequences, or the orders of the components are not limited by the terms. When one component is described as being “connected”, “coupled”, or “attached” to another component, it should be understood that one component may be connected or attached directly to another component, and an intervening component may also be “connected”, “coupled”, or “attached” to the components.

The same name may be used to describe an element included in the embodiments described above and an element having a common function. Unless stated otherwise, the description of an embodiment may be applicable to other embodiments, and a repeated description thereto is omitted.

As is traditional in the field, the embodiments are described, and illustrated in the drawings, in terms of functional blocks, units and/or modules. Those skilled in the art will appreciate that these blocks, units and/or modules are physically implemented by electronic (or optical) circuits such as logic circuits, discrete components, microprocessors, hard-wired circuits, memory elements, wiring connections, and the like, which may be formed using semiconductor-based fabrication techniques or other manufacturing technologies. In the case of the blocks, units and/or modules being implemented by microprocessors or similar, they may be programmed using software (e.g., microcode) to perform various functions discussed herein and may optionally be driven by firmware and/or software. Alternatively, each block, unit and/or module may be implemented by dedicated hardware, or as a combination of dedicated hardware to perform some functions and a processor (e.g., one or more programmed microprocessors and associated circuitry) to perform other functions. Also, each block, unit and/or module of the embodiments may be physically separated into two or more interacting and discrete blocks, units and/or modules without departing from the present scope. Further, the blocks, units and/or modules of the embodiments may be physically combined into more complex blocks, units and/or modules without departing from the present scope.

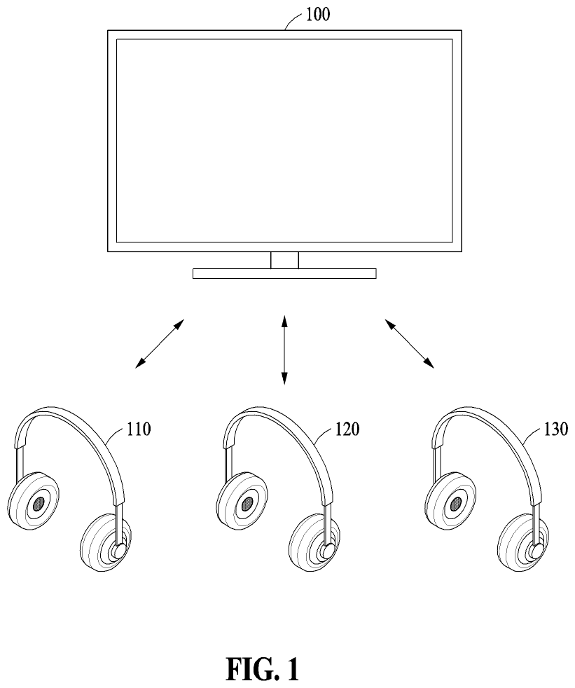

Hereinafter, a Bluetooth connection control device and method are described in detail with reference to FIGS. 1 to 9.

FIG. 1 is a diagram illustrating a schematic configuration of a Bluetooth system according to an embodiment.

Referring to FIG. 1, the Bluetooth system may include a host device 100 and a plurality of Bluetooth devices 110, 120, and 130.

The host device 100 may operate in one of a first connection mode and a second connection mode to establish communication with the Bluetooth devices 110, 120, and 130 via Bluetooth depending on a connection mode supported by the Bluetooth devices 110, 120, and 130.

In this case, the first connection mode may represent a mode for establishing a Bluetooth connection using a Bluetooth low energy (BLE) technique and the second connection mode may represent a mode for establishing a Bluetooth connection using a classic Bluetooth technique.

In other words, the first connection mode may be a new mode with improved performance, and the second connection mode may be an existing mode with lower performance or lower battery efficiency than the first connection mode that is commonly used.

In this case, in a transition period in which there is a host device that only provides the existing second connection mode, a Bluetooth device using the first connection mode for communication may support both the first connection mode and the second connection mode to communicate with the host device that only provides the existing second connection mode.

When the Bluetooth devices 110, 120, and 130 support both the first connection mode and the second connection mode, the host device 100 may be connected to all of the Bluetooth devices 110, 120, and 130 in the first connection mode.

When any of the Bluetooth devices 110, 120, and 130 supports only the second connection mode, the host device 100 may be connected to all of the Bluetooth devices 110, 120, and 130 in the first connection mode.

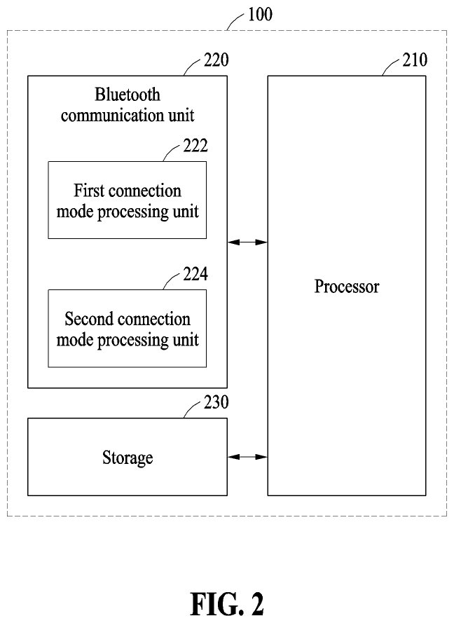

FIG. 2 is a diagram illustrating a configuration of a host device of a Bluetooth system according to an embodiment.

Referring to FIG. 2, the host device 100 may include a processor 210, a Bluetooth communication unit 220, and a storage 230.

The Bluetooth communication unit 220 may include a first connection mode processing unit 222 that processes a connection scheme of a first connection mode during Bluetooth communication and a second connection mode processing unit 224 that processes a connection scheme of a second connection mode during Bluetooth communication to perform Bluetooth communication with Bluetooth devices.

The storage 230 may store an operating system for controlling the overall operation of the host device 100 and application programs or data. In addition, when a Bluetooth device that supports both the first connection mode and the second connection mode is registered, the storage 230 may store first connection information (e.g., a Bluetooth address) used to establish a connection using the first connection mode corresponding to the Bluetooth device and second connection information used to establish a connection using the second connection mode, and when a Bluetooth device that supports only the second connection mode is registered, the storage 230 may store the second connection information corresponding to the Bluetooth device.

The storage 230 may include read-only memory (ROM), random-access memory (RAM), or a memory card (e.g., a micro secure digital (SD) card and a universal serial bus (USB) memory) mounted to the host device 100. In addition, a memory 960 may include a non-volatile memory, a volatile memory, a hard disk drive (HDD), or a solid state drive (SSD).

According to an embodiment, the storage 230 may include at least one type of storage medium of flash memory-type memory, hard disk-type memory, multimedia card micro-type memory, card-type memory (e.g., SD or extreme digital (XD) memory), RAM, static RAM (SRAM), ROM, electrically erasable programmable ROM (EEPROM), programmable ROM (PROM), magnetic memory, a magnetic disk, and an optical disk.

The processor 210, when detecting a Bluetooth connection event, may identify a current mode indicating a current Bluetooth connection mode and may control establishment of a connection by determining whether to establish a connection with a connection target device using the first connection mode or the second connection mode considering the current mode and a connection mode supported by the connection target device. In this case, the Bluetooth connection event may occur when a user enters a menu and selects a Bluetooth connection menu or may occur when a preset Bluetooth connection button is input.

The processor 210 may identify, between the first connection mode and the second connection mode, a connection mode supported by the connection target device representing a connection target Bluetooth device.

Also, when the connection target device supports both the first connection mode and the second connection mode, the processor 210 may register the first connection information (e.g., a Bluetooth address) corresponding to the first connection mode and the second connection information corresponding to the second connection mode.

When performing pairing in the first connection mode, the connection target device that supports both the first connection mode and the second connection mode may transmit not only the first connection information but also the second connection information.

When the connection target device that supports both the first connection mode and the second connection mode performs pairing in the first connection mode and does not transmit the second connection information, the processor 210 may control information to be output through a pop-up menu to perform pairing in the second connection mode and may obtain the second connection information by performing pairing in the second connection mode to register the second connection information.

When the connection target device supports only the second connection mode, the processor 210 may register the second connection information corresponding to the second connection mode.

When the connection target device supports both the first connection mode and the second connection mode and the current mode is the first connection mode, the processor 210 may establish a connection with the connection target device using the first connection mode, and when the connection target device supports both the first connection mode and the second connection mode and the current mode is the second connection mode, the processor 210 may establish a connection with the connection target device using the second connection mode.

When the connection target device supports only the second connection mode and the current mode is the second connection mode, the processor 210 may establish a connection with the connection target device using the second connection mode, and when the connection target device supports only the second connection mode and the current mode is the first connection mode, the processor 210 may change a connection mode of a previously connected device to the second connection mode and establish a connection with the connection target device using the second connection mode.

On the other hand, when the current mode is the second connection mode, the processor 210 may detect a reconnection request from a registered device by performing Bluetooth scanning corresponding to the second connection mode at preset intervals and may establish a Bluetooth connection with the registered device requesting a reconnection using the second connection mode when detecting the reconnection request from the registered device.

When the current mode is the first connection mode, the processor 210 may detect the reconnection request from the registered device by performing Bluetooth scanning corresponding to the first connection mode and Bluetooth scanning corresponding to the second connection mode in order at preset intervals, may establish a Bluetooth connection with the registered device requesting a reconnection using the first connection mode when detecting the reconnection request from the registered device during the Bluetooth scanning corresponding to the first connection mode, and may change the connection mode of the previously connected device to the second connection mode and establish a Bluetooth connection with the registered device requesting a reconnection using the second connection mode when detecting the reconnection request from the registered device during the Bluetooth scanning corresponding to the second connection mode.

When the current mode is yet to be set, e.g., before the current mode is set, the processor 210 may detect the reconnection request from the registered device by performing the Bluetooth scanning corresponding to the first connection mode and the Bluetooth scanning corresponding to the second connection mode at preset intervals, may establish a Bluetooth connection with the registered device requesting a reconnection using the first connection mode when detecting the reconnection request from the registered device during the Bluetooth scanning corresponding to the first connection mode, and may establish a Bluetooth connection with the registered device requesting a reconnection using the second connection mode when detecting the reconnection request from the registered device during the Bluetooth scanning corresponding to the second connection mode.

The processor 210 may, when the current mode is the first connection mode and disconnection of one of connected registered devices is detected, verify whether there are remaining connected registered devices and when there are remaining connected registered devices, may maintain the current mode as the first connection mode.

The processor 210 may, when the current mode is the second connection mode and disconnection of one of the connected registered devices is detected, verify whether there are remaining connected registered devices, when there are remaining connected registered devices, may verify whether there is a device that supports only the second connection mode among the remaining connected registered devices, when it is verified that there is a device that supports only the second connection mode among the remaining connected registered devices, may maintain the current mode as the second connection mode, and when it is verified that there is no device that supports only the second connection mode, may change the current mode to the first connection mode and reestablish a connection with the remaining connected registered devices using the first connection mode.

Hereinafter, a method according to the present disclosure configured as described above will be described with reference to the drawings.

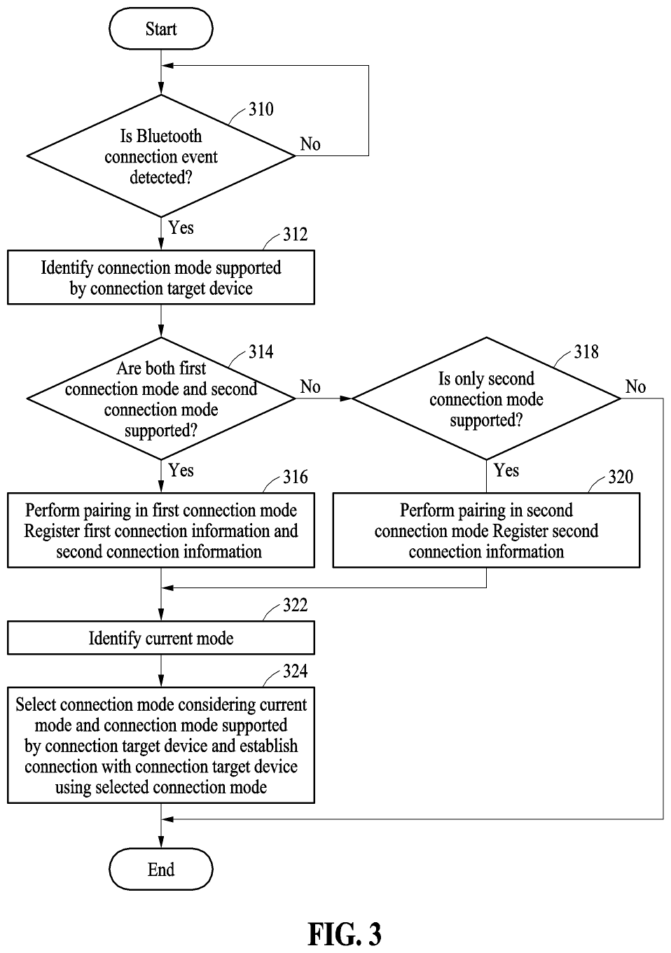

FIG. 3 is a flowchart illustrating a process of controlling a connection of a new Bluetooth device by a host device of a Bluetooth system according to an embodiment.

Referring to FIG. 3, when detecting a Bluetooth connection event (310), the host device 100 may identify a connection mode supported by a connection target device between a first connection mode and a second connection mode (312). In this case, the first connection mode may represent a mode for establishing a Bluetooth connection using a BLE technique and the second connection mode may represent a mode for establishing a Bluetooth connection using a classic Bluetooth technique.

Then, when the connection target device supports both the first connection mode and the second connection mode (314), the host device 100 may register first connection information corresponding to the first connection mode and second connection information corresponding to the second connection mode (316).

Then, when the connection target device supports only the second connection mode (318), the host device 100 may register the second connection information corresponding to the second connection mode (320).

Then, the host device 100 may identify a current mode indicating a current Bluetooth connection mode (322).

Then, the host device 100 may select one connection mode from the first connection mode or the second connection mode considering the current mode and the connection mode supported by the connection target device and may establish a connection with the connection target device using the selected connection mode (324).

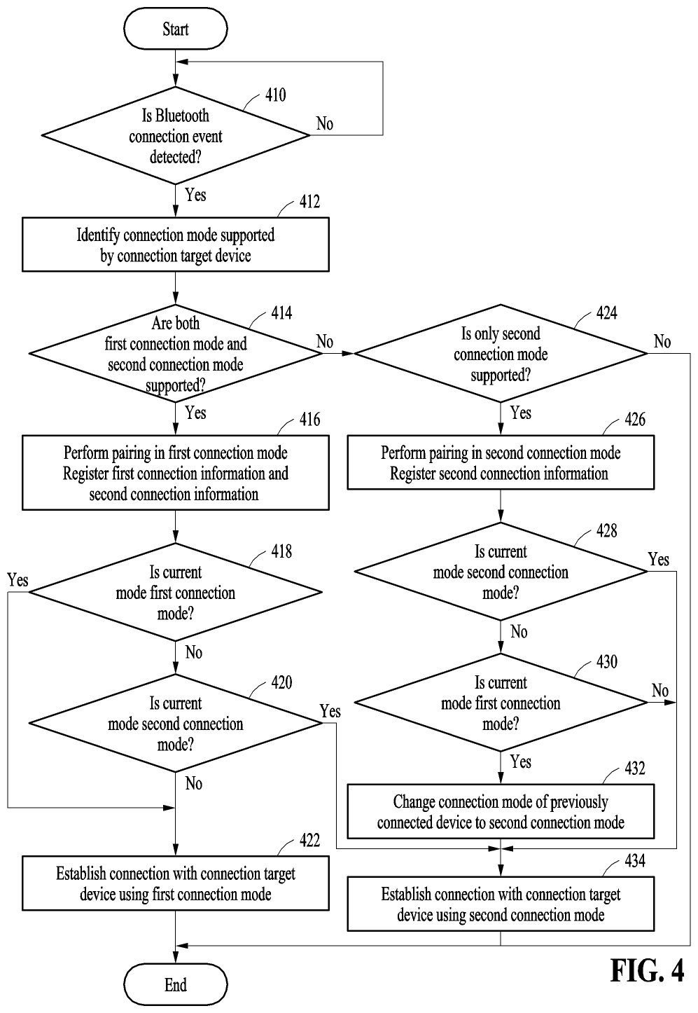

FIG. 4 is a flowchart illustrating a detailed process of controlling a connection of a new Bluetooth device by a host device of a Bluetooth system according to an embodiment.

Referring to FIG. 4, when detecting a Bluetooth connection event (410), the host device 100 may identify a connection mode supported by a connection target device between a first connection mode and a second connection mode (412). In this case, the first connection mode may represent a mode for establishing a Bluetooth connection using a BLE technique and the second connection mode may represent a mode for establishing a Bluetooth connection using a classic Bluetooth technique.

Then, when the connection target device supports both the first connection mode and the second connection mode (414), the host device 100 may register first connection information corresponding to the first connection mode and second connection information corresponding to the second connection mode (416).

Then, when the connection target device supports both the first connection mode and the second connection mode and a current mode is the first connection mode (418), the host device 100 may establish a connection with the connection target device using the first connection mode (422).

Then, when the connection target device supports both the first connection mode and the second connection mode and the current mode is the second connection mode (420), the host device 100 may establish a connection with the connection target device using the second connection mode (434).

According to embodiments, when the connection target device supports only the second connection mode (424), the host device 100 may register the second connection information corresponding to the second connection mode (426).

Then, when the connection target device supports only the second connection mode and the current mode is the second connection mode (428), the host device 100 may establish a connection with the connection target device using the second connection mode (434).

Then, when the connection target device supports only the second connection mode and the current mode is the first connection mode (430), the host device 100 may change a connection mode of a previously connected device to the second connection mode (432) and may establish a connection with the connection target device using the second connection mode (434).

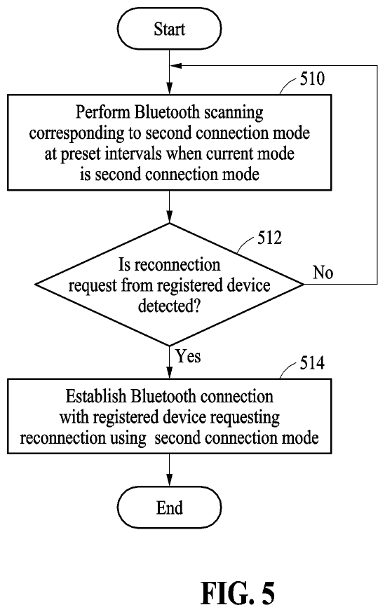

FIG. 5 is a flowchart illustrating a process of controlling a reconnection of a Bluetooth device while operating in a second connection mode by a host device of a Bluetooth system according to an embodiment.

Referring to FIG. 5, when a current mode is a second connection mode, the host device 100 may detect a reconnection request from a registered device by performing Bluetooth scanning corresponding to the second connection mode at preset intervals (510).

Then, when a Bluetooth connection signal corresponding to the second connection mode is scanned and a reconnection request from a registered device is detected (512), the host device 100 may establish a Bluetooth connection with the registered device requesting a reconnection using the second connection mode (514).

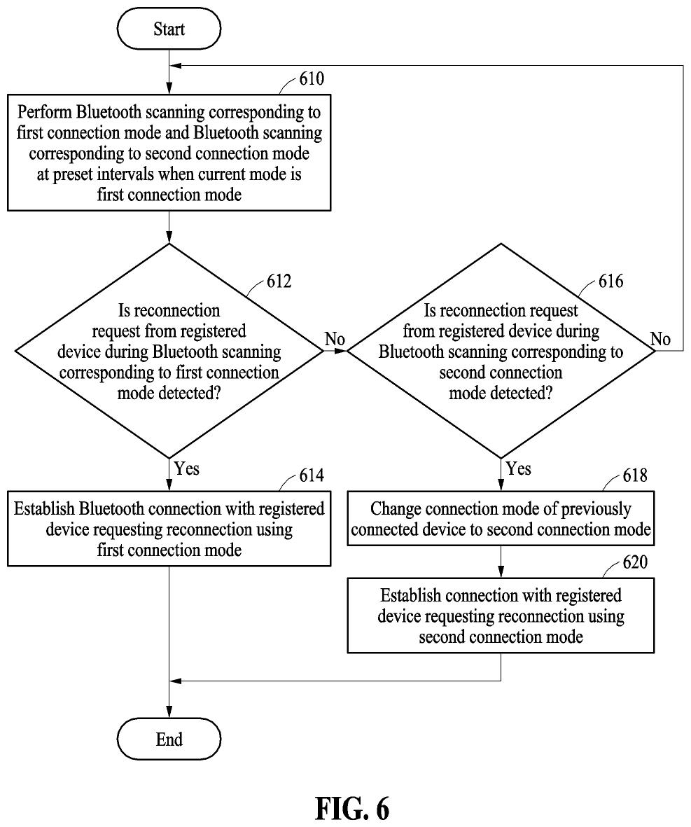

FIG. 6 is a flowchart illustrating a process of controlling a reconnection of a Bluetooth device while operating in a first connection mode by a host device of a Bluetooth system according to an embodiment.

Referring to FIG. 6, when a current mode is a first connection mode, the host device 100 may detect a reconnection request from a registered device by performing Bluetooth scanning corresponding to the first connection mode and Bluetooth scanning corresponding to a second connection mode at preset intervals.

Then, when detecting the reconnection request from the registered device during the Bluetooth scanning corresponding to the first connection mode (612), the host device 100 may establish a Bluetooth connection with the registered device requesting a reconnection using the first connection mode.

Then, when detecting the reconnection request from the registered device during the Bluetooth scanning corresponding to the second connection mode (616), the host device 100 may change a connection mode of a previously connected device to the second connection mode (618) and may establish a Bluetooth connection with the registered device requesting a reconnection using the second connection mode (620).

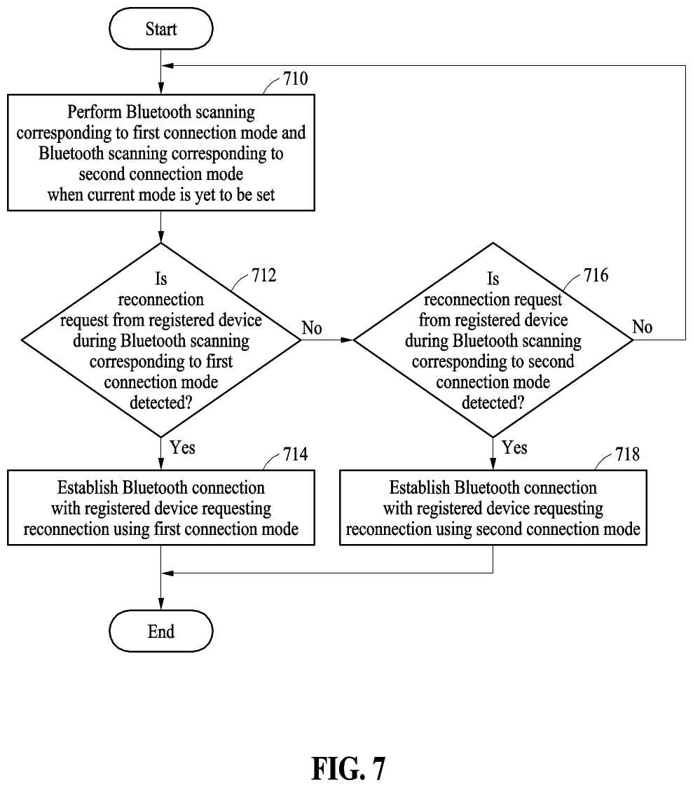

FIG. 7 is a flowchart illustrating a process of controlling a reconnection of a Bluetooth device, when a current mode is yet to be set, by a host device of a Bluetooth system according to an embodiment.

Referring to FIG. 7, when a current mode is yet to be set, the host device 100 may detect a reconnection request from a registered device by performing Bluetooth scanning corresponding to a first connection mode and Bluetooth scanning corresponding to a second connection mode at preset intervals (710).

Then, when detecting the reconnection request from the registered device during the Bluetooth scanning corresponding to the first connection mode (712), the host device 100 may establish a Bluetooth connection with the registered device requesting a reconnection using the first connection mode (714).

Then, when detecting the reconnection request from the registered device during the Bluetooth scanning corresponding to the second connection mode (716), the host device 100 may establish a Bluetooth connection with the registered device requesting a reconnection using the second connection mode (718).

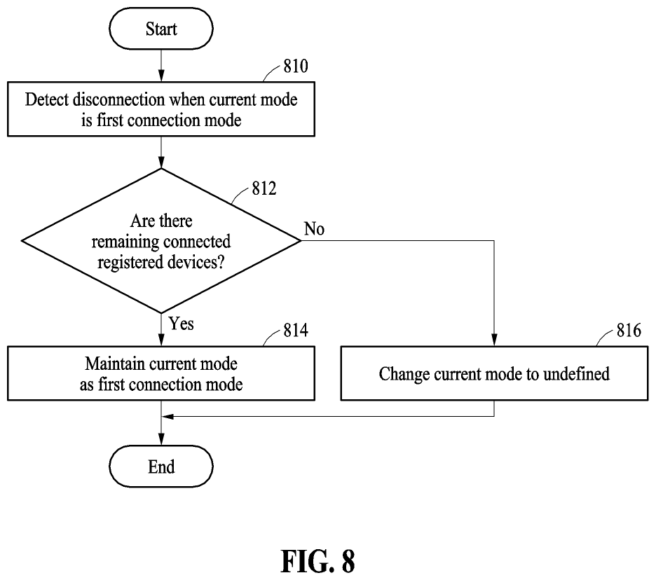

FIG. 8 is a flowchart illustrating a processing process when a Bluetooth device is disconnected from a host device of a Bluetooth system while operating in a first connection mode, according to an embodiment.

Referring to FIG. 8, when a current mode is a first connection mode and disconnection of one of connected registered devices is detected (810), the host device 100 may verify whether there are remaining connected registered devices (812).

When it is verified in operation 812 that there are remaining connected registered devices, the host device 100 may maintain the current mode as the first connection mode (814).

When it is verified in operation 812 that there is no remaining connected registered device, the host device 100 may change the current mode to undefined (816).

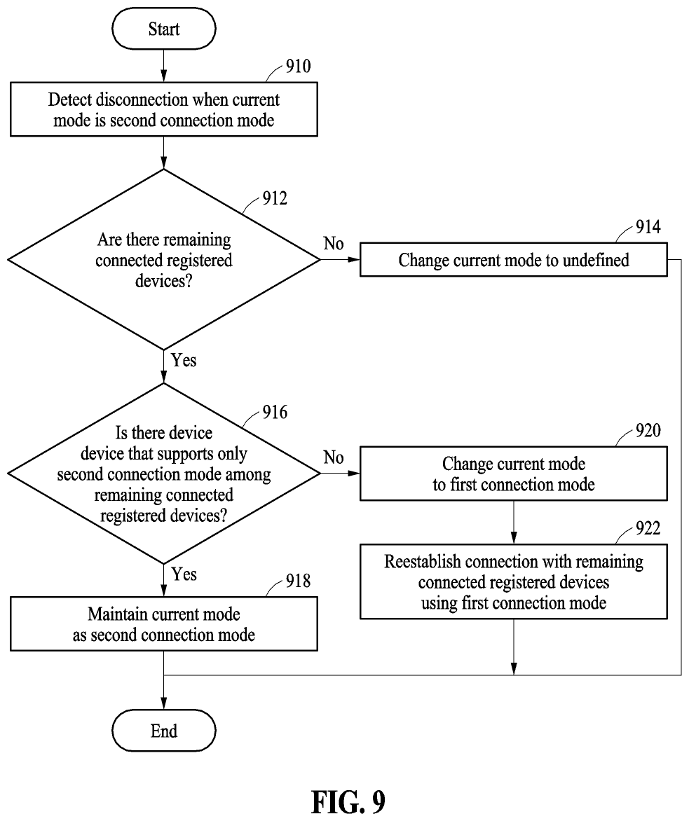

FIG. 9 is a flowchart illustrating a processing process when a Bluetooth device is disconnected from a host device of a Bluetooth system while operating in a second connection mode, according to an embodiment.

Referring to FIG. 9, when a current mode is a second connection mode, the host device 100 may detect disconnection of one of connected registered devices (910).

Then, the host device 100 may verify whether there are remaining connected registered devices (912).

When it is verified in operation 912 that there is no remaining connected registered device, the host device 100 may change the current mode to undefined (914).

When it is verified in operation 912 that there are remaining connected registered devices, the host device 100 may verify whether there is a device that supports only the second connection mode among the remaining connected registered devices (916).

When it is verified in operation 916 that there is a device that supports only the second connection mode among the remaining connected registered devices, the host device 100 may maintain the current mode as the second connection mode (918).

When it is verified in operation 916 that there is no device that supports only the second connection mode among the remaining connected registered devices, the host device 100 may change the current mode to the first connection mode (920) and may reestablish a connection with the remaining connected registered devices using the first connection mode (922).

The methods according to the above-described embodiments may be recorded in computer-readable media including program instructions to implement various operations of the above-described embodiments. The computer-readable media may store program instructions, data files, data structures, and the like, either individually or in combination. The program instructions recorded on the media may be those designed and constructed for the purposes of embodiments, or they may be of the kind well-known and available to those having skill in the computer software arts. Examples of computer-readable media include magnetic media such as hard disks, floppy disks, and magnetic tape; optical media such as CD-ROM discs or DVDs; magneto-optical media such as Floptical disks; and hardware devices that are configured to store and perform program instructions, such as ROM, RAM, flash memory, and the like. Examples of program instructions include both machine code, such as produced by a compiler, and higher-level code that may be executed by the computer using an interpreter, and the like. The above-described hardware devices may be configured to act as one or more software modules to perform the operations of the above-described embodiments, or vice versa.

The software may include a computer program, a piece of code, an instruction, or some combination thereof, to independently or collectively instruct or configure the processing device to operate as selected. Software and/or data may be embodied permanently or temporarily in any type of machine, component, physical or virtual equipment, computer storage medium or device, or in a propagated signal wave capable of providing instructions or data to or being interpreted by the processing device. The software also may be distributed over network-coupled computer systems so that the software is stored and executed in a distributed fashion. The software and data may be stored by one or more computer-readable recording mediums.

While the embodiments are described with reference to drawings, it will be apparent to one of ordinary skill in the art that various alterations and modifications in form and details may be made in these embodiments without departing from the spirit and scope of the claims and their equivalents. For example, suitable results may be achieved if the described techniques are performed in a different order, and/or if components in a described system, architecture, device, or circuit are combined in a different manner, or replaced or supplemented by other components or their equivalents.

Therefore, other implementations, other embodiments, and equivalents to the claims are also within the scope of the following claims.

What is claimed is:

1. A method of controlling a Bluetooth connection on a Bluetooth host device, the method comprising:
detecting a Bluetooth connection event;
identifying a connection mode supported by a connection target device, between a first connection mode and a second connection mode;
when the connection target device supports both the first connection mode and the second connection mode, registering first connection information corresponding to the first connection mode and second connection information corresponding to the second connection mode;
when the connection target device supports the second connection mode and does not support the first connection mode, registering the second connection information corresponding to the second connection mode; and
identifying a current mode indicating a current Bluetooth connection mode, selecting one connection mode from the first connection mode or the second connection mode considering the current mode and the connection mode supported by the connection target device, and establishing a connection with the connection target device using the selected connection mode.

2. The method of claim 1, wherein the establishing of the connection with the connection target device using the selected connection mode comprises:
when the connection target device supports both the first connection mode and the second connection mode and the current mode is the first connection mode, establishing the connection with the connection target device using the first connection mode; and
when the connection target device supports both the first connection mode and the second connection mode and the current mode is the second connection mode, establishing the connection with the connection target device using the second connection mode.

3. The method of claim 1, wherein the establishing of the connection with the connection target device using the selected connection mode comprises:
when the connection target device supports the second connection mode and does not support the first connection mode and the current mode is the second connection mode, establishing the connection with the connection target device using the second connection mode; and
when the connection target device supports the second connection mode and does not support the first connection mode and the current mode is the first connection mode, changing a connection mode of a previously connected device to the second connection mode and establishing the connection with the connection target device using the second connection mode.

4. The method of claim 1, wherein the first connection mode indicates a mode for establishing a Bluetooth connection using a Bluetooth low energy (BLE) technique.

5. The method of claim 1, wherein the second connection mode indicates a mode for establishing a Bluetooth connection using a classic Bluetooth technique.

6. The method of claim 1, further comprising:
when the current mode is the second connection mode, detecting a reconnection request from a registered device by performing Bluetooth scanning corresponding to the second connection mode at preset intervals; and
when the reconnection request from the registered device is detected, establishing a Bluetooth connection with the registered device requesting a reconnection using the second connection mode.

7. The method of claim 1, further comprising:
when the current mode is the first connection mode, detecting a reconnection request from a registered device by performing Bluetooth scanning corresponding to the first connection mode and Bluetooth scanning corresponding to the second connection mode at preset intervals;
when the reconnection request from the registered device is detected during the Bluetooth scanning corresponding to the first connection mode, establishing a Bluetooth connection with the registered device requesting a reconnection using the first connection mode; and
when the reconnection request from the registered device is detected during the Bluetooth scanning corresponding to the second connection mode, changing a connection mode of a previously connected device to the second connection mode and establishing a Bluetooth connection with the registered device requesting a reconnection using the second connection mode.

8. The method of claim 1, further comprising:
before the current mode is set, detecting a reconnection request from a registered device by performing Bluetooth scanning corresponding to the first connection mode and Bluetooth scanning corresponding to the second connection mode at preset intervals;
when the reconnection request from the registered device is detected during the Bluetooth scanning corresponding to the first connection mode, establishing a Bluetooth connection with the registered device requesting a reconnection using the first connection mode; and
when the reconnection request from the registered device is detected during the Bluetooth scanning corresponding to the second connection mode, establishing a Bluetooth connection with the registered device requesting a reconnection using the second connection mode.

9. The method of claim 1, further comprising:
when the current mode is the first connection mode and disconnection of one of connected registered devices is detected, verifying whether there are remaining connected registered devices; and
when there are the remaining connected registered devices, maintaining the current mode as the first connection mode.

10. The method of claim 1, further comprising:
when the current mode is the second connection mode and disconnection of one of connected registered devices is detected, verifying whether there are remaining connected registered devices;
when there are the remaining connected registered devices, verifying whether there is a device supporting the second connection mode and does not support the first connection mode among the remaining connected registered devices;
when it is verified that there is the device supporting the second connection mode and does not support the first connection mode among the remaining connected registered devices, maintaining the current mode as the second connection mode; and
when it is verified that there is no device supporting the second connection mode among the remaining connected registered devices, changing the current mode to the first connection mode and reestablishing a connection with the remaining connected registered devices using the first connection mode.

11. A method of controlling a Bluetooth connection on a Bluetooth host device, the method comprising:
when a current mode indicating a current Bluetooth connection mode is a first connection mode, detecting a reconnection request from a registered device by performing Bluetooth scanning corresponding to the first connection mode and Bluetooth scanning corresponding to a second connection mode at preset intervals;
when the reconnection request from the registered device is detected during the Bluetooth scanning corresponding to the first connection mode, establishing a Bluetooth connection with the registered device requesting a reconnection using the first connection mode; and
when the reconnection request from the registered device is detected during the Bluetooth scanning corresponding to the second connection mode, changing a connection mode of a previously connected device to the second connection mode and establishing a Bluetooth connection with the registered device requesting a reconnection using the second connection mode.

12. The method of claim 11, further comprising:
when the current mode is the second connection mode and disconnection of one of connected registered devices is detected, verifying whether there are remaining connected registered devices;
when there are the remaining connected registered devices, verifying whether there is a device supporting the second connection mode and does not support the first connection mode among the remaining connected registered devices;
when it is verified that there is the device supporting the second connection mode and does not support the first connection mode among the remaining connected registered devices, maintaining the current mode as the second connection mode; and
when it is verified that there is no device supporting the second connection mode and does not support the first connection mode among the remaining connected registered devices, changing the current mode to the first connection mode and reestablishing a connection with the remaining connected registered devices using the first connection mode.

13. A Bluetooth connection control device comprising:
a Bluetooth communication unit comprising a first connection mode processing unit configured to process a connection scheme of a first connection mode during Bluetooth communication and a second connection mode processing unit configured to process a connection scheme of a second connection mode during the Bluetooth communication; and
a processor configured to, when detecting a Bluetooth connection event, identify a current mode indicating a current Bluetooth connection mode and control establishment of a connection by determining whether to establish a connection with a connection target device using the first connection mode or the second connection mode considering the current mode and a connection mode supported by the connection target device,
wherein the processor is configured to identify the connection mode supported by the connection target device between the first connection mode and the second connection mode and when the connection target device supports both the first connection mode and the second connection mode, register first connection information corresponding to the first connection mode and second connection information corresponding to the second connection mode.

14. The Bluetooth connection control device of claim 13, wherein the processor is configured to, when the connection target device supports the second connection mode, register the second connection information corresponding to the second connection mode.

15. The Bluetooth connection control device of claim 13, wherein the processor is configured to:
when the connection target device supports both the first connection mode and the second connection mode and the current mode is the first connection mode, establish a connection with the connection target device using the first connection mode; and
when the connection target device supports both the first connection mode and the second connection mode and the current mode is the second connection mode, establish a connection with the connection target device using the second connection mode.
